(19) United States
(12) Patent Application Publication
(10) Pub. No.: US 2024/0402776 A1
(43) Pub. Date: Dec. 5, 2024

(54) MAGNETIC DISK DEVICE, METHOD FOR CONTROLLING MAGNETIC DISK DEVICE, AND COMPUTER PROGRAM PRODUCT

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Kozo SUEISHI, Kawasaki Kanagawa (JP)

(21) Appl. No.: 18/427,672

(22) Filed: Jan. 30, 2024

(30) Foreign Application Priority Data
May 29, 2023 (JP) 2023-088055

(51) Int. Cl. G06F 1/26

(52) U.S. Cl. CPC G06F 1/263

(57) ABSTRACT

A magnetic disk device according to an embodiment operates by receiving power supply from a first power source and a second power source. The first power source supplies power with a first voltage. The second power source supplies power with a second voltage higher than the first voltage. The magnetic disk device includes a first control device and a second control device. The first control device detects whether or not power cutoff has occurred in either one of the first power source and the second power source. When the first control device detects the power cutoff having occurred in either one of the first/second power sources, the second control device causes the other one of the first/second power sources to supply power to an unnecessary circuit until power down processing is completed in the unnecessary circuit. The unnecessary circuit is a circuit whose power supply is to be stopped.

### CROSS-REFERENCE TO RELATED APPLICATIONS

This application is based upon and claims the benefit of priority from Japanese Patent Application No. 2023-088055, filed on May 29, 2023; the entire contents of which are incorporated herein by reference.

### FIELD

Embodiments described herein relate generally to a magnetic disk device, a method for controlling a magnetic disk device, and a computer program product.

### BACKGROUND

A hard disk drive device as a magnetic disk device is provided with a power loss protection (PLP) function being a data protection measure for unexpected power interruption.

The PLP function is a function to write data that has been stored in a DRAM to a FROM by using a counter electromotive force (PLP power source) generated by a disk motor for driving a disk, when the disk is stopped.

Conventionally, in a case where cutoff of external power source 5 V/12 V occurs, a system on chip (SoC) detects an input of a fault signal (Fault signal) from a servo controller (SVC) and unconditionally cuts off power supply from the external power source. The SoC then switches to a PLP function using a counter electromotive force (PLP power source) generated by the disk motor.

### BRIEF DESCRIPTION OF THE DRAWINGS

FIG. 1 is a block diagram illustrating an example of a schematic configuration of a main part of a magnetic disk device according to an embodiment;

FIG. 2 is a diagram illustrating an example of a timing chart in a case where a 5 V external power source is cut off;

FIG. 3 is a flowchart illustrating an example of a procedure of processing during PLP operation according to the embodiment;

FIG. 4 is a diagram illustrating an example of a timing chart in a case where a 12 V external power source is cut off;

FIG. 5 is a diagram illustrating an example of a timing chart in a case where there is no data as PLP operation target; and

FIG. 6 is a diagram illustrating an example of a timing chart of a reference example for contrasting with the embodiment of the present disclosure.

### DETAILED DESCRIPTION

A magnetic disk device according to an embodiment operates by receiving power supply from a first power source and a second power source. The first power source supplies power with a first voltage. The second power source supplies power with a second voltage higher than the first voltage. The magnetic disk device includes a first control device and a second control device. The first control device detects whether or not power cutoff has occurred in either one of the first power source and the second power source. When the first control device detects the power cutoff having occurred in either one of the first/second power sources, the second control device causes the other one of the first/second power sources to supply power to an unnecessary circuit until power down processing is completed in the unnecessary circuit. The unnecessary circuit is a circuit whose power supply is to be stopped.

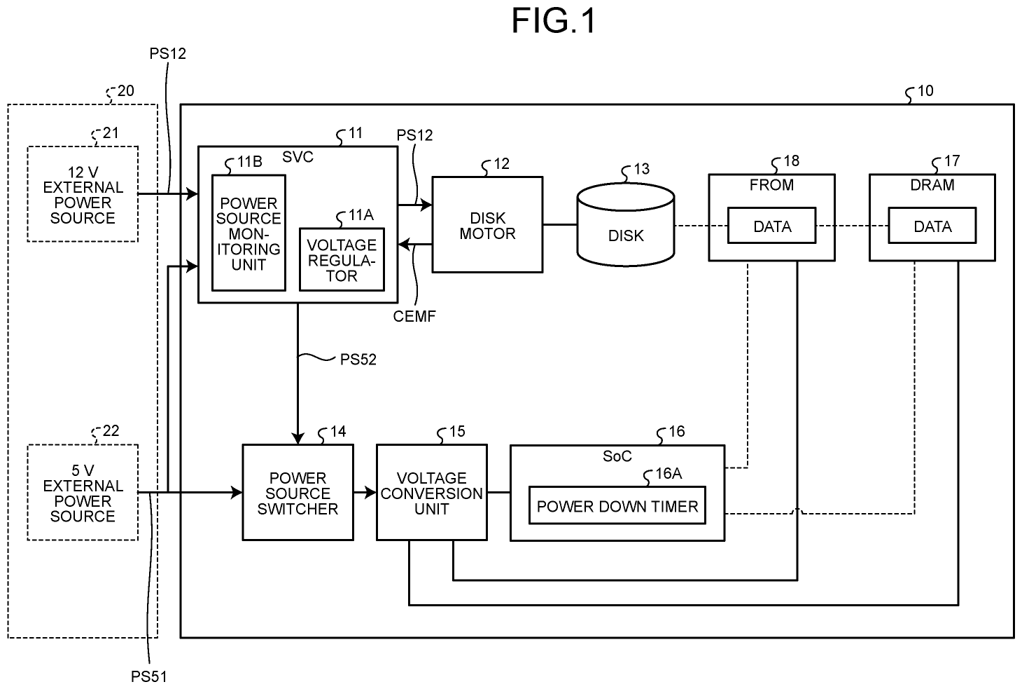

An embodiment will be described in detail with reference to the drawings. FIG. 1 is a block diagram of a schematic configuration of a main part of a magnetic disk device according to the embodiment. The magnetic disk device of the embodiment is configured as a hard disk drive device (HDD device).

A magnetic disk device 10 includes a servo controller (SVC) 11 (an example of the first control device), a disk motor 12, a disk 13, a power source switcher 14, a voltage conversion unit 15, a system on a chip (SoC) 16 (an example of the second control device), a DRAM 17, and a FROM 18. In addition, an external power source system 20 including a 12 V external power source 21 (an example of the second power source) and a 5 V external power source 22 (an example of the first power source) is connected to the magnetic disk device 10.

The servo controller (SVC) 11 is supplied with 12 V power PS12 from the 12 V external power source 21 of the external power source system 20, and controls the disk motor 12 to perform servo control. The servo controller 11 includes a voltage regulator 11A (an example of a voltage conversion circuit) and a power source monitoring unit 11B.

The voltage regulator 11A performs power conversion for servo control, performs voltage conversion of the 12 V power PS12, and outputs 5 V power PS52 to the power source switcher 14.

The power source monitoring unit 11B monitors voltage of the 12 V power PS12 supplied from the 12 V external power source 21 and voltage of 5 V power PS51 supplied from the 5 V external power source 22. The power source monitoring unit 11B then outputs a Fault signal to be described later to the SoC 16 when a voltage abnormality such as power cutoff is detected in either one of the power sources 21 and 22.

The disk motor 12 rotationally drives the (magnetic) disk 13 under the control of the servo controller 11.

The disk 13 magnetically records various data. The power source switcher 14 is supplied with the 5 V power PS51 from the 5 V external power source 22 of the external power source system 20, and is supplied with the 5 V power PS52from the voltage regulator 11A of the servo controller 11. The power source switcher 14 outputs either one of the powers PS51 and PS52to the voltage conversion unit 15.

The voltage conversion unit 15 supplies power to each unit (the SoC 16, the DRAM 17, and the FROM 18 in an example of FIG. 1) of the magnetic disk device 10 on the basis of the 5 V power PS51 or the 5 V power PS52, which is given from the power source switcher 14.

The SoC 16 functions as a controller (control device) that controls the entire magnetic disk device 10 and performs control for implementing a PLP function to back up data from the DRAM 17 to the FROM 18. The DRAM 17 is a volatile memory that stores data before performing write processing on the disk 13.

The FROM 18 is a nonvolatile memory that stores data having been stored in the DRAM 17 for backup when the PLP function is executed.

Prior to a detailed description of the embodiment, a principle of the embodiment will be described. In the magnetic disk device that operates by receiving supply of power from the 12 V external power source 21 (second power source) and the 5 V external power source 22 (first power source), there are few cases where both the 12 V external power source 21 and the 5 V external power source 22 are cut off at the same timing.

Considering the above, in the present embodiment, when either one of the 12 V external power source 21 and the 5 V external power source 22 is cut off and power supply therefrom is lost, the other one of the power sources 21 and 22, which is able to supply power, is effectively used for supplying power to a circuit that does not need to operate in PLP operation (hereinafter referred to as an unnecessary circuit). Then, the PLP operation using a counter electromotive force (CEMF) of the disk motor 12 illustrated in FIG. 1 is performed after stop processing of the unnecessary circuit is reliably performed, thereby avoiding the various problems described above.

This is to use the power source that is not cut off until completion of power down of the unnecessary circuit performed in a time unit of us before both the power sources are finally cut off after a lapse of a time unit of ms in view of fail-safe.

As described above, by using the power source that is not cut off until the power down of the unnecessary circuit, the power source before the power down of the unnecessary circuit can be stabilized, and a failure risk due to a PLP power source drop can be avoided.

Next, operation of the present embodiment will be described in detail. In the present embodiment, the two external power sources are provided as the 12 V external power source 21 and the 5 V external power source 22. There are the following two aspects of using one of the 12 V external power source 21 and the 5 V external power source 22.

A first aspect is an aspect in a case where the 5 V external power source 22 is cut off. In the first aspect, power that has been converted from 12 V to 5 V by the voltage regulator 11A of the servo controller 11 is used. A second aspect is an aspect in a case where the 12 V external power source 21 is cut off. In the second aspect, power output from the 5 V external power source 22 is used without voltage conversion.

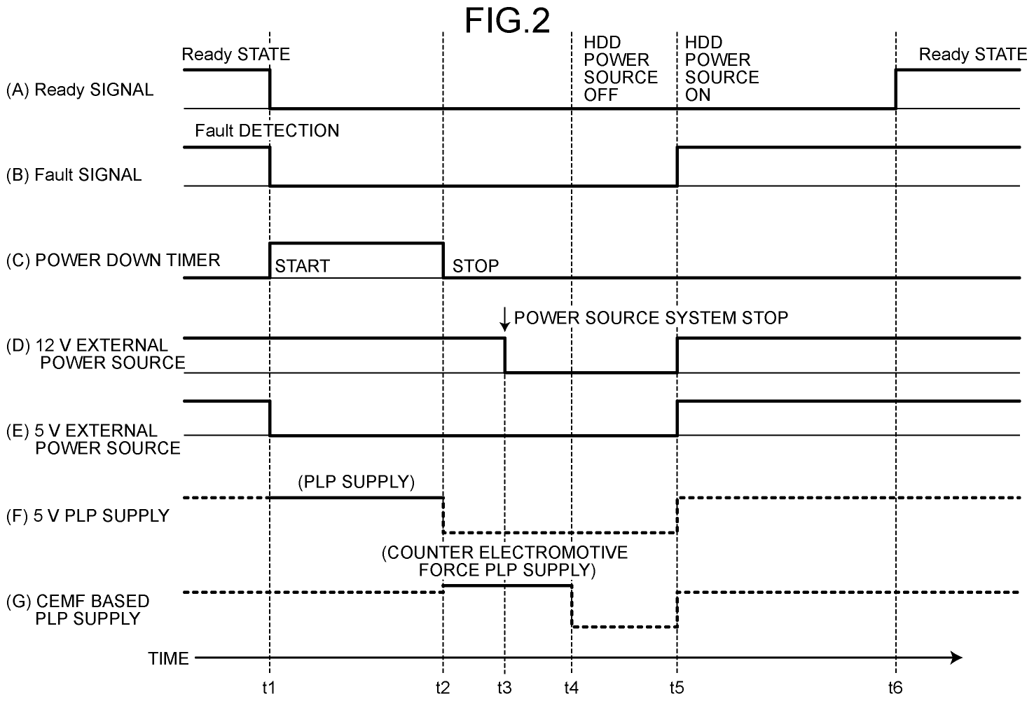

First, the operation in the case of the first aspect in which the 5 V external power source 22 is cut off will be described. FIG. 2 is a timing chart in a case where the 5 V external power source is cut off. A waveform (A) in FIG. 2 represents a signal level of a Ready signal that is set to an “H” level by the SoC 16 when the magnetic disk device 10 can perform normal operation.

A waveform (B) in FIG. 2 represents a signal level of a Fault signal that is set to an “L” level when the power source monitoring unit 11B of the servo controller 11 detects an abnormality in at least one of the 12 V external power source 21 and the 5 V external power source 22.

A waveform (C) in FIG. 2 represents a signal output by a power down timer 16A of the SoC 16 that counts up time required to reliably perform stop processing (power down processing) of all unnecessary circuits when the Fault signal becomes the “L” level and becomes an “H” level during a count-up period. Therefore, when the count-up is completed and a signal output by the power down timer 16A once turns to the “H” level and then turns to the “L” level, all the unnecessary circuits are reliably in a stop state.

A waveform (D) in FIG. 2 represents a signal in the SoC 16, which becomes an “H” level in a power suppliable state of the 12 V external power source 21 and becomes an “L” level in a cutoff state of the 12 V external power source 21.

A waveform (E) in FIG. 2 represents a signal in the SoC 16, which becomes an “H” level in a power suppliable state of the 5 V external power source 22 and becomes an “L” level in a cutoff state of the 5 V external power source 22.

A waveform (F) in FIG. 2 represents a supply state of the PLP power source from the external power source in place of the PLP power source using a counter electromotive force (CEMF) described later. In the waveform (F) in FIG. 2, a solid line represents an actual power supply state, and a broken line represents a power suppliable state.

A waveform (G) in FIG. 2 represents a supply state of the PLP power source using a counter electromotive force (CEMF). In the waveform (G) in FIG. 2, a solid line represents an actual power supply state, and a broken line represents a power suppliable state.

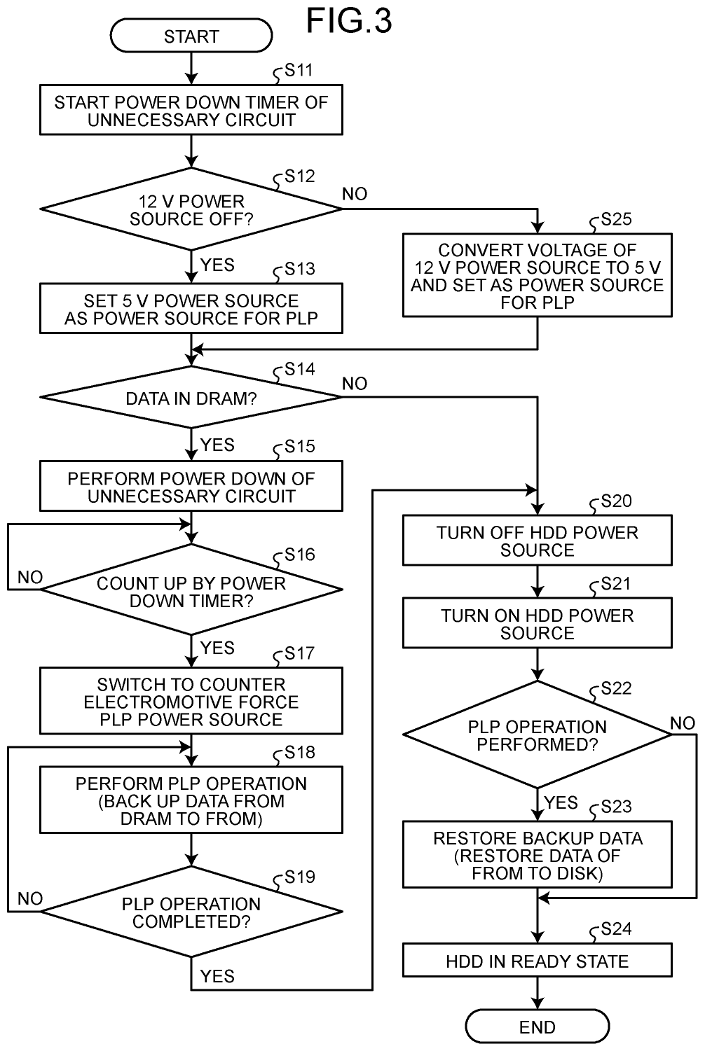

FIG. 3 is a processing flowchart during PLP operation according to the embodiment. Hereinafter, the operation in the case of the first aspect in which the 5 V external power source 22 is cut off will be described in detail with reference to the timing chart of FIG. 2 and the processing flowchart of FIG. 3.

At time t1 in FIG. 2, when the 5 V external power source 22 is cut off as illustrated in the waveform (E), the power source monitoring unit 11B of the servo controller (SVC) 11 sets the Fault signal to the “L” level as shown in the waveform (B). Then, the SoC 16 sets the Ready signal to an “L” level as shown in the waveform (A).

The SoC 16 starts processing during PLP operation illustrated in FIG. 3. At time t1 in FIG. 2, in order to implement a PLP function, the SoC 16 starts (initiates) counting by the power down timer 16A for an unnecessary circuit that is a circuit not used in PLP processing as illustrated in the waveform (C) in FIG. 2 (step S11).

Subsequently, the SoC 16 determines whether or not the 12 V external power source is cut off (turned off) (step S12).

In this case, as illustrated at time t1 in the waveform (D) in FIG. 2, an output of the 12 V external power source 21 is detected by the power source monitoring unit 11B. Thus, the servo controller 11 make a determination that the 12 V external power source 21 is not cut off (turned off) (step S12; No). The voltage regulator 11A of the servo controller 11 performs voltage conversion of the 12 V power PS12 and outputs the 5 V power PS52 to the power source switcher 14. The SoC 16 sets the 5 V power PS52 as a power source for a PLP circuit (step S25). Then, as illustrated at time t1 in the waveform (F) in FIG. 2, the SoC 16 supplies power to the PLP circuit and supplies the 5 V power PS52 converted by the voltage regulator 11A of the servo controller 11 to the unnecessary circuit.

Therefore, unlike the conventional art, there is no need to supply power to the unnecessary circuit from the PLP power source utilizing the counter electromotive force. Therefore, a drop of power supply voltage of the PLP circuit due to the power supply can be prevented.

Subsequently, in order to shift to data backup, the SoC 16 determines whether or not there is data before processing in the DRAM 17 (step S14). The reason for determining whether or not there is data before processing in the DRAM 17 is, as described later, to prevent the PLP operation from being performed because performing the PLP operation even through there is no data to be backed up may cause a trouble.

In response to determining in step S14 that there is data before processing in the DRAM 17 (step S14; Yes), it is necessary to perform the PLP operation and thus power down of the unnecessary circuit that is unnecessary for the PLP operation is performed (step S15).

The SoC 16 determines whether or not count-up by the power down timer 16A has stopped by that, the count-up has ended at time t2 that is set in advance as time after the power down of the unnecessary circuit is reliably performed and completed (step S16).

In response to determining in step S16 that the count-up by the power down timer 16A has not been stopped yet (step S16; No), a standby state is set.

In response to determining in step S16 that the count-up by the power down timer 16A has stopped (halted) at time t2 in FIG. 2 (step S16; Yes), it is not necessary to supply power to the unnecessary circuit, as illustrated in the waveform (G), and thus the counter electromotive force of the disk motor is used as the PLP power source as in the conventional case (step S17). At the same time, as illustrated at time t2 in the waveform (F) in FIG. 2, 5 V power supply to the PLP circuit from the 12 V external power source 21 via the voltage regulator 11A of the servo controller (SVC) 11 is stopped. Then, from the viewpoint of fail-safe, the 12 V external power source 21 is stopped at time t3.

Therefore, the PLP operation can be performed while performing the power down of the unnecessary circuit by using the stable power source. The PLP operation can be reliably completed, and reliability of the magnetic disk device 10 can be enhanced.

As a result, the power source is continuously supplied to the DRAM 17 that is a PLP target. Then, the SoC 16 performs the PLP operation of transferring the data to be backed up stored in the DRAM 17 to the FROM 18 and backing up the data (step S18).

Subsequently, the SoC 16 determines whether or not the PLP operation has been completed (step S19). In response to determining in step S19 that the PLP operation has not been completed yet, a standby state is set. In response to determining in step S19 that the PLP operation has been completed, as illustrated at time t4 in FIG. 2, the SoC 16 turns off a power source of the magnetic disk device 10 in order to restart the magnetic disk device 10 (step S20).

After turning off the power source of the magnetic disk device 10, the SoC 16 turns on the power source of the magnetic disk device 10 at time t5 at which it can be reliably estimated that the magnetic disk device 10 has returned to an initial state, and restarts the magnetic disk device 10 (step S21).

Subsequently, the SoC 16 determines whether or not the PLP operation has been performed last time (step S22).

Specifically, the SoC 16 determines whether or not the PLP operation of transferring the data to be backed up stored in the DRAM 17 to the FROM 18 and backing up the data has been performed in step S18. In response to determining in step S22 that the PLP operation has not been performed (step S22; No), the process proceeds to step S24.

In response to determining in step S22 that the PLP operation has been performed (step S22; Yes), the SoC 16 reads data to be backed up from the FROM 18 and restores the data to the disk 13 (step S23). As a result, the magnetic disk device 10 performs startup time processing and returns to a ready state, which is a normal state, at time t6.

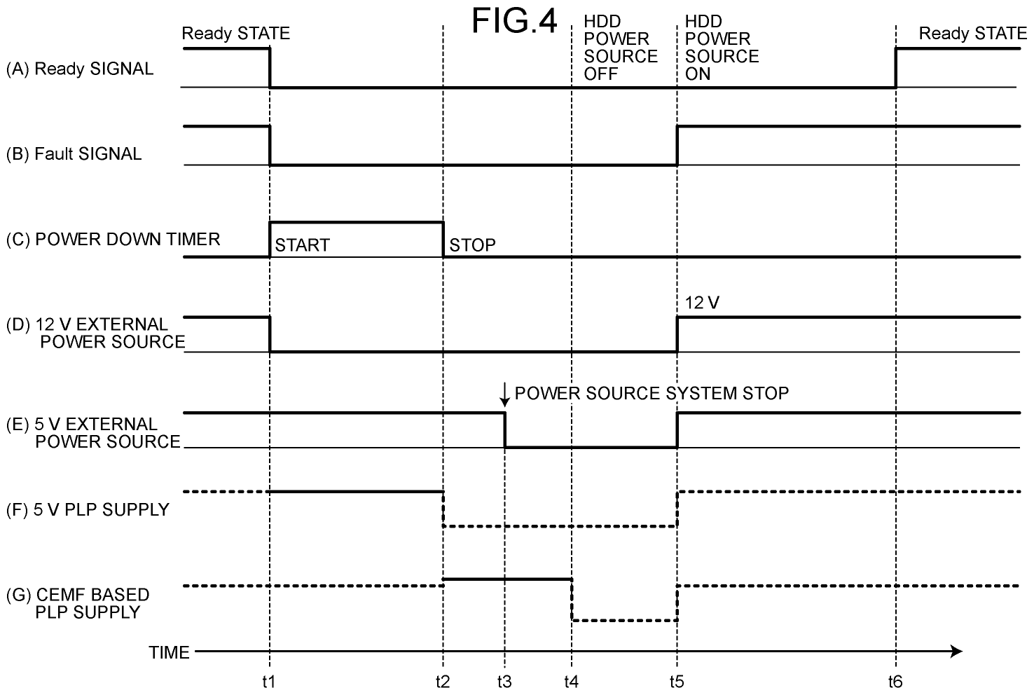

Next, operation in the case of the second aspect in which the 12 V external power source 21 is cut off will be described. FIG. 4 is a timing chart in a case where the 12 V external power source is cut off. Waveforms (A) to (G) illustrated in FIG. 4 correspond to the waveforms (A) to (G) illustrated in FIG. 2, respectively, so that detailed description thereof is incorporated.

FIG. 4 differs from FIG. 2 in that, the 12 V external power source 21 is in a cutoff state as illustrated in the waveform (D) in FIG. 4, and the 5 V external power source 22 is in a power suppliable state as illustrated in the waveform (E) in FIG. 4. Thus, the PLP power source illustrated in the waveform (F) in FIG. 4 is power from the 5 V external power source 22.

Hereinafter, the operation in the case of the second aspect in which the 12 V external power source 21 is cut off will be described in detail with reference to the timing chart of FIG. 4 and the processing flowchart of FIG. 3.

At time t1 in FIG. 4, when the 12 V external power source 21 is cut off as illustrated in the waveform (D), the power source monitoring unit 11B of the servo controller (SVC) 11 sets the Fault signal to the “L” level as shown in the waveform (B). As a result, the SoC 16 sets the Ready signal to the “L” level as shown in the waveform (A) in FIG. 4.

The SoC 16 starts the processing during the PLP operation illustrated in FIG. 3. At time t1 in FIG. 4, in order to implement a PLP function, the SoC 16 starts (initiates) counting by the power down timer 16A for an unnecessary circuit that is a circuit not used in PLP processing as illustrated in the waveform (C) in FIG. 4 (step S11).

Subsequently, the SoC 16 determines whether or not the 12 V external power source is cut off (turned off) (step S12). In this case, as illustrated at time t1 in the waveform (D) in FIG. 4, an output of the 12 V external power source 21 is not detected by the power source monitoring unit 11B. Thus, the servo controller 11 make a determination that the 12 V external power source 21 is cut off (turned off) (step S12; Yes).

The SoC 16 sets the 5 V power PS51 from the 5 V external power source 22 as a power source for the PLP circuit (step S13). Then, as illustrated at time t1 in the waveform (F) in FIG. 4, the SoC 16 supplies the power to the PLP circuit and supplies the 5 V power PS51 to the unnecessary circuit.

Therefore, also in this case, unlike the conventional case, there is no need to supply power to the unnecessary circuit from the PLP power source utilizing the counter electromotive force, and the stable 5 V power PS51 from the 5 V external power source 22 is supplied. Therefore, a drop of power supply voltage of the PLP circuit can be prevented.

Subsequently, in order to shift to data backup, the SoC 16 determines whether or not there is data before processing in the DRAM 17 (step S14).

In response to determining in step S14 that there is data before processing in the DRAM 17 (step S14; Yes), it is necessary to perform the PLP operation and thus power down of the unnecessary circuit that is unnecessary for the PLP operation is performed (step S15).

The SoC 16 determines whether or not count-up by the power down timer 16A has stopped by that, the count-up has ended at time t2 that is set in advance as time after the power down of the unnecessary circuit is reliably performed and completed (step S16).

In response to determining in step S16 that the count-up by the power down timer 16A has not been stopped yet (step S16; No), a standby state is set.

In response to determining in step S16 that the count-up by the power down timer 16A has stopped (halted) at time t2 in FIG. 4 (step S16; Yes), it is not necessary to supply power to the unnecessary circuit, as illustrated in the waveform (G) in FIG. 4, and thus the counter electromotive force of the disk motor is used as the PLP power source as in the conventional case (step S17). At the same time, as illustrated at time t2 in the waveform (F) in FIG. 4, 5 V power supply from the 5 V external power source 22 to the PLP circuit is stopped. Then, from the viewpoint of fail-safe, the 5 V external power source 22 is stopped at time t3.

Therefore, the PLP operation can be performed while performing the power down of the unnecessary circuit by using the stable power source. The PLP operation can be reliably completed, and reliability of the magnetic disk device 10 can be enhanced.

As a result, the power source is continuously supplied to the DRAM 17 that is a PLP target. Then, the SoC 16 performs the PLP operation of transferring the data to be backed up stored in the DRAM 17 to the FROM 18 and backing up the data (step S18).

Subsequently, the SoC 16 determines whether or not the PLP operation has been completed (step S19). In response to determining in step S19 that the PLP operation has not been completed yet, a standby state is set. In response to determining in step S19 that the PLP operation has been completed, as illustrated at time t4 in FIG. 4, the SoC 16 turns off the power source of the magnetic disk device 10 in order to restart the magnetic disk device 10 (step S20).

After turning off the power source of the magnetic disk device 10, the SoC 16 turns on the power source of the magnetic disk device 10 at time t5 at which it can be reliably estimated that the magnetic disk device 10 has returned to an initial state, and restarts the magnetic disk device 10 (step S21). Subsequently, the SoC 16 determines whether or not the PLP operation has been performed (step S22).

Specifically, the SoC 16 determines whether or not the PLP operation of transferring the data to be backed up stored in the DRAM 17 to the FROM 18 and backing up the data has been performed in step S18.

In response to determining in step S22 that the PLP operation has been performed (step S22; Yes), the SoC 16 reads data to be backed up from the FROM 18 and restores the data to the disk 13 (step S23). As a result, the magnetic disk device 10 performs startup time processing and returns to the ready state, which is a normal state, at time t6.

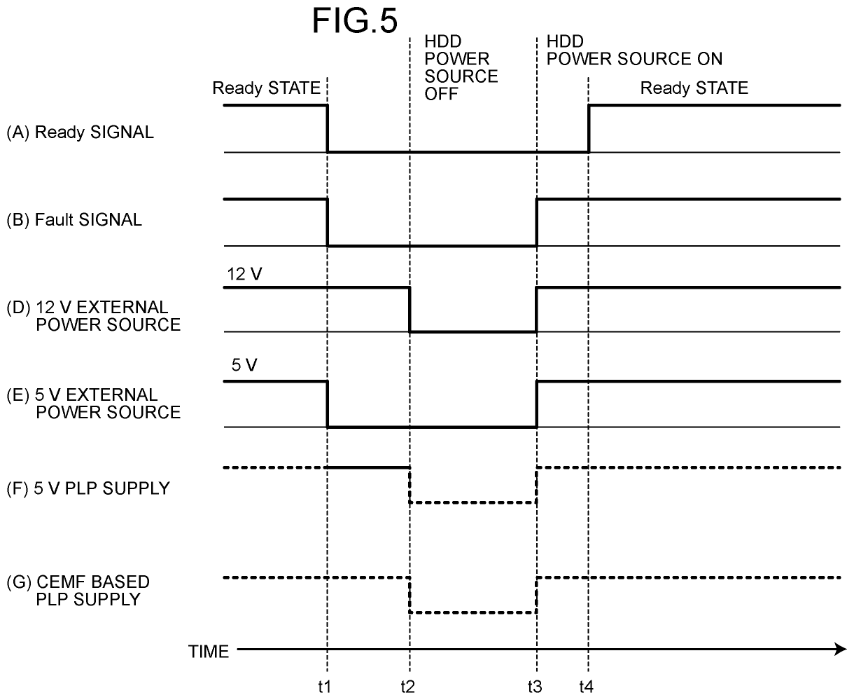

The operation in a case where there is data to be backed up has been described. However, as described above, there is a possibility that performing the PLP operation even though there is no data to be backed up causes trouble. Therefore, hereinafter, operation in a case where there is no data to be backed up will be described with reference to a timing chart of FIG. 5 and the processing flowchart of FIG. 3.

FIG. 5 is a timing chart in a case where there is no data as PLP operation target.

Waveforms (A) to (B) and (D) to (G) illustrated in FIG. 5 correspond to the waveforms (A) to (B) and (D) to (G) illustrated in FIG. 2, respectively, and thus the detailed description thereof is incorporated.

FIG. 5 is different from FIG. 2 in that, it is not necessary to perform the PLP operation, and thus processing immediately shifts to restart processing of the magnetic disk device at time t2 without performing power down processing of an unnecessary circuit. Note that, in FIG. 5, as in the case of FIG. 2, although a timing chart in a case where the 5 V external power source 22 is cut off is illustrated, the same applies to a case where the 12 V external power source 21 is cut off.

Hereinafter, the operation in a case where there is no data as PLP operation target will be described with reference to the timing chart of FIG. 5 and the flowchart of FIG. 3. At time t1, as illustrated in the waveform (E) in FIG. 5, when the 5V external power source 22 is cut off, the Ready signal and the Fault signal are at the “L” level as shown in the waveforms (A) and (B) in FIG. 5.

The SoC 16 starts counting by the power down timer of an unnecessary circuit that is a circuit not used in PLP processing in order to implement a PLP function (step S11). Subsequently, the SoC 16 determines whether or not the 12 V external power source is cut off (turned off) (step S12).

As illustrated at time t1 in the waveform (D) in FIG. 5, an output of the 12 V external power source 21 is detected by the power source monitoring unit 11B. Thus, the servo controller 11 makes a determination that the 12 V external power source 21 is not cut off (turned off) (step S12; No). The voltage regulator 11A of the servo controller 11 performs voltage conversion of the 12 V power PS12 and outputs the 5 V power PS52 to the power source switcher 14.

The SoC 16 sets the 5 V power PS52 as a power source for the PLP circuit (step S25). As illustrated at time t1 in the waveform (F) in FIG. 5, the SoC 16 supplies power to the PLP circuit and supplies the 5 V power PS52 converted by the voltage regulator 11A of the servo controller 11 to the unnecessary circuit.

Therefore, also in this case, the PLP power source using the counter electromotive force does not need to supply power to the unnecessary circuit. Therefore, a drop of power supply voltage of the PLP circuit due to power supply can be prevented.

Then, in order to shift to data backup, the SoC 16 determines whether or not there is data before processing in the DRAM 17 (step S14). In this case, the DRAM 17 has no data before processing (step S14; No) and it is not necessary to perform the PLP operation. Therefore, as illustrated at time t2 in FIG. 5, the SoC 16 turns off the power source of the magnetic disk device 10 in order to immediately restart the magnetic disk device 10 (step S20).

After turning off the power source of the magnetic disk device 10, the SoC 16 turns on the power source of the magnetic disk device 10 at time t3 at which it can be reliably estimated that the magnetic disk device 10 has returned to an initial state, and restarts the magnetic disk device 10, as illustrated at time t3 in FIG. 5 (step S21).

Subsequently, the SoC 16 determines whether or not it is necessary to perform the PLP operation (step S22). Since the data to be backed up is not stored in the FROM 18, the SoC makes a determination that it is not necessary to perform the PLP operation. The magnetic disk device 10 performs the startup time processing and returns to the ready state, which is a normal state, at time t4 in FIG. 5.

Therefore, as compared with the case of performing the PLP operation described with reference to FIGS. 2 and 4, it is not necessary to perform the power down processing of the unnecessary circuit, the data backup processing, and write-back processing of the backup data to the disk 13. Thus, it is possible to reduce a failure risk associated with the PLP operation and shorten a restart time of the magnetic disk device.

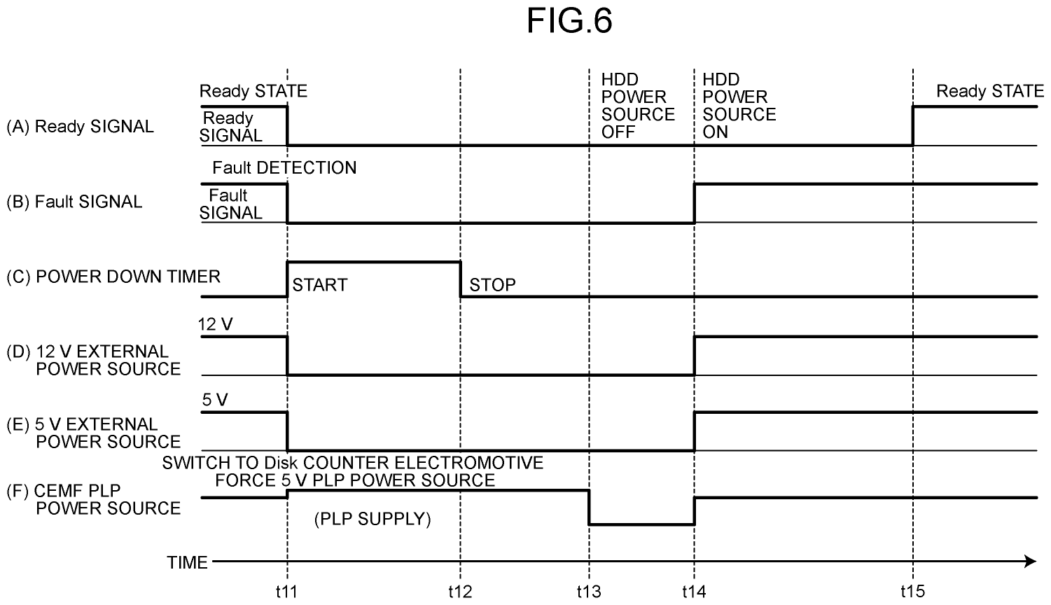

Next, effects of the embodiment will be described in comparison with a reference example. Hereinafter, for easy understanding, the description will be made with reference to FIG. 1. FIG. 6 is a diagram illustrating an example of a timing chart of a reference example for contrasting with the embodiment of the present disclosure. In the reference example, when the 5 V external power source or the 12 V external power source is cut off, the SoC detects the Fault signal (low active) from the servo controller and unconditionally executes switching to a PLP function.

More specifically, assuming that the 5 V external power source 22 is cut off at time t11, the Ready signal and the Fault signal are at the “L” level as shown in waveforms (A) and (B) in FIG. 6.

As a result, as illustrated in a waveform (C) in FIG. 6, the SoC 16 starts counting by the power down timer of an unnecessary circuit that is a circuit not used in PLP processing in order to implement a PLP function (step S11). From the viewpoint of fail-safe, the SoC 16 stops the 12 V external power source 21 and the 5 V external power source 22 as illustrated in waveforms (D) and (E) in FIG. 6.

As a result, before power down of the unnecessary circuit for preventing a decrease of the 5 V PLP power source is completed, switching to a disk motor counter electromotive force PLP power source is started, as illustrated in a waveform (F) in FIG. 6. Since it is before the power down of the unnecessary circuit, there has been a possibility that a failure risk of the PLP function caused by a drop of the PLP power source occurs due to the operation of the unnecessary circuit.

In addition, even if backup data does not exist in the DRAM, such as at the time of power interruption during data read (Read), the processing is forcibly shifted to the PLP processing. Therefore, there has been a possibility that a failure risk due to the PLP processing occurs and a restart time becomes long due to unnecessary PLP switching.

However, it is rare that both the 12 V external power source 21 and the 5 V external power source 22 are simultaneously shut off. According to the magnetic disk device 10 of the embodiment of the present disclosure, when one of the 12 V external power source 21 and the 5 V external power source 22 is cut off for some reason, the other power source that is not cut off is used until the power down of the unnecessary circuit unnecessary for the PLP operation. Therefore, it is possible to suppress occurrence of a failure such as a voltage drop of the PLP power source.

Moreover, determination is made as to whether or not it is necessary to actually perform the PLP operation, and the PLP operation is not performed in response to determining that it is not necessary. Therefore, a processing procedure is simplified. According to the embodiment, it is possible to achieve improvement of function and reduction in startup time by stabilizing the power source before power down of the unnecessary circuit and eliminating unnecessary PLP switching.

Note that a computer program executed by the magnetic disk device of the present embodiment is provided as a computer program product stored in advance on a non-transitory computer-readable recording medium such as a ROM. The program executed by the magnetic disk device according to the present embodiment may be provided as a computer program product by being recorded in a file in an installable format or an executable format in a semiconductor memory device such as a USB memory or a solid state drive (SSD) or a computer-readable recording medium such as a digital versatile disk (DVD).

Moreover, the program executed by the magnetic disk device of the present embodiment may be stored on a computer connected to a network such as the Internet and provided by being downloaded via the network. In addition, the program executed by the magnetic disk device of the present embodiment may be provided or distributed via the network such as the Internet.

While some embodiments have been described, these embodiments have been presented by way of example only and are not intended to limit the scope of the inventions. Indeed, the novel embodiments described herein can be embodied in a variety of other forms; moreover, various omissions, substitutions and changes can be made without departing from the gist of the inventions. These embodiments or modifications thereof are included in the scope or the gist of the inventions and are included in the inventions described in the claims and an equivalent scope thereof.

What is claimed is:

1. A magnetic disk device operating by receiving power supply from a first power source and a second power source, the first power source supplying power with a first voltage, the second power source supplying power with a second voltage higher than the first voltage, the magnetic disk device comprising:
a first control device configured to detect whether or not power cutoff has occurred in either one of the first power source and the second power source; and
a second control device configured, when the first control device detects the power cutoff having occurred in either one of the first or second power sources, to cause the other one of the first or second power sources to supply power to an unnecessary circuit until power down processing is completed in the unnecessary circuit, the unnecessary circuit being a circuit whose power supply is to be stopped.

2. The magnetic disk device according to claim 1, wherein, when power is supplied to the unnecessary circuit, the second control device supplies power for PLP operation from the other one of the first or second power sources to a PLP circuit.

3. The magnetic disk device according to claim 2, further comprising a PLP power source supplying the power for PLP operation to the PLP circuit,
wherein, when the power down processing is completed in the unnecessary circuit, the second control device stops power supply from the other one of the first or second power source to the PLP circuit and starts power supply from the PLP power source to the PLP circuit.

4. The magnetic disk device according to claim 3, wherein the second control device cuts off the other one of the first or second power source after the start of power supply from the PLP power source to the PLP circuit.

5. The magnetic disk device according to claim 1, wherein
the first control device includes a voltage conversion circuit configured to convert a voltage of power supplied from the second power source into the first voltage when power cutoff has occurred in the first power source, and
the second control device supplies the power supplied from the second power source to the unnecessary circuit via the voltage conversion circuit.

6. The magnetic disk device according to claim 1, further comprising a PLP circuit configured to perform PLP operation, wherein
the second control device
determines whether or not the PLP operation is necessary when the power cutoff has occurred in either one of the power sources, and,
in response to determining that the PLP operation is not necessary, cuts off power to the magnetic disk device and causes the magnetic disk device to perform restart operation without causing the PLP circuit to perform the PLP operation.

7. A method of controlling a magnetic disk device, the magnetic disk device operating by receiving power supply from a first power source and a second power source, the first power source supplying power with a first voltage, the second power source supplying power with a second voltage higher than the first voltage, the method comprising:
detecting whether or not power cutoff has occurred in either one of the first power source and the second power source; and,
when the detecting detects the power cutoff having occurred in either one of the first or second power sources, causing the other one of the first or second power sources to supply power to an unnecessary circuit until power down processing is completed in the unnecessary circuit, the unnecessary circuit being a circuit whose power supply is to be stopped.

8. The method according to claim 7, wherein the causing to supply power includes supplying power for PLP operation from the other one of the first or second power sources to a PLP circuit.

9. The method according to claim 8, wherein
the magnetic disk device includes a PLP power source supplying the power for PLP operation to the PLP circuit, and
the causing to supply power includes, when the power down processing is completed in the unnecessary circuit, stopping power supply from the other one of the first second power source to the PLP circuit and starting power supply from the PLP power source to the PLP circuit.

10. The method according to claim 9, further comprising cutting off the other one of the first second power source after the starting of power supply from the PLP power source to the PLP circuit.

11. The method according to claim 7, wherein
the magnetic disk device includes a voltage conversion circuit converting a voltage of power supplied from the second power source into the first voltage when power cutoff has occurred in the first power source, and
the causing to supply power includes supplying the power supplied from the second power source to the unnecessary circuit via the voltage conversion circuit.

12. The method according to claim 7, wherein
the magnetic disk device includes a PLP circuit configured to perform PLP operation, and
the method further comprises
determining whether or not the PLP operation is necessary when the power cutoff has occurred in either one of the power sources, and,
in response to determining that the PLP operation is not necessary, cutting off power to the magnetic disk device and causing the magnetic disk device to perform restart operation without causing the PLP circuit to perform the PLP operation.

13. A computer program product comprising a non-transitory computer-readable recording medium on which a program executable by a computer is recorded, the program instructing the computer to execute processing of controlling a magnetic disk device, the magnetic disk device operating by receiving power supply from a first power source and a second power source, the first power source supplying power with a first voltage, the second power source supplying power with a second voltage higher than the first voltage, the processing to be executed by the computer including:
detecting whether or not power cutoff has occurred in either one of the first power source and the second power source; and,
when the detecting detects the power cutoff having occurred in either one of the first or second power sources, causing the other one of the first or second power sources to supply power to an unnecessary circuit until power down processing is completed in the unnecessary circuit, the unnecessary circuit being a circuit whose power supply is to be stopped.
